(19) United States
(12) Patent Application Publication
(10) Pub. No.: US 2025/0348743 A1
(43) Pub. Date: Nov. 13, 2025

(54) VIRTUAL SOLUTION ARCHITECT

(71) Applicant: SAP SE, Walldorf (DE)

(72) Inventor: Vivek RANJAN, Sunnyvale, CA (US)

(21) Appl. No.: 18/658,322

(22) Filed: May 8, 2024

(51) Int. Cl. G06N 3/091; G06N 3/042

(52) U.S. Cl. CPC G06N 3/091; G06N 3/042

(57) ABSTRACT

A virtual solution architect (VSA) for facilitating the design of technology solution architectures via a natural language interface is provided. In one set of embodiments, the VSA can collect various types of knowledge relevant to technology solution design, such as a knowledge graph of business processes and their relationships, information pertaining to the application programming interfaces (APIs) of packaged business capabilities (PBCs), and so on. The VSA can further receive a natural language query pertaining to a technology solution architecture, retrieve at least a portion of the collected knowledge based on the query, and build a prompt for a large language model (LLM) using the query and the retrieved knowledge. The VSA can then provide the prompt as input to the LLM, thereby causing the LLM to output a natural language answer to the natural language query, and can provide the answer to the query originator.

### BACKGROUND

Packaged business capabilities (PBCs) are independent, composable pieces of software that implement business capabilities (or portions thereof) that are part of current business processes. For example, in the domain of electronic commerce, one PBC may implement customer account registration and management, another PBC may implement product catalogs, and yet another PBC may implement shopping cart functionality. Due to their composable nature, PBCs can be combined into a custom technology solution that meets the business needs of a particular organization.

### BRIEF DESCRIPTION OF THE DRAWINGS

FIG. 1 depicts an architecture of a virtual solution architect (VSA) according to certain embodiments.

FIG. 2 depicts a first VSA knowledge collection workflow according to certain embodiments.

FIG. 3 depicts a second VSA knowledge collection workflow according to certain embodiments.

FIG. 4 depicts an example set of knowledge graph nodes according to certain embodiments.

FIG. 5 depicts a VSA query processing workflow according to certain embodiments.

FIG. 6 depicts an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to an automated agent, referred to as a virtual solution architect (VSA), that leverages generative artificial intelligence (AI) (and in particular, generative AI-based large language models (LLMs)) to aid users in designing technology solution architectures via a natural (human) language interface. As used herein, a technology solution architecture (hereinafter referred to as simply a solution architecture) comprises a set of PBCs and a technical plan or blueprint on how those PBCs should be composed, configured, and/or deployed in order to achieve the business objectives of a target organization. In one set of embodiments, the VSA of the present disclosure may be implemented by companies that develop and sell PBCs (such as, e.g., enterprise software companies) for the purpose of streamlining the design of solution architectures based on those PBCs for their customers. In another set of embodiments, the VSA may be implemented by an organization in order to facilitate its internal information technology (IT) workflows.

The task of designing solution architectures can be carried out manually by human solution architects that have comprehensive knowledge of the PBCs available for use, an understanding of solution design best practices with respect to security, data architecture, and regulatory requirements, and experience in synthesizing all of this information (along with other technical and strategic considerations) to conceptualize a solution architecture for a given party that meets the party's business needs and objectives. However, it will likely become increasingly difficult for human solution architects to fulfill this role in an adequate and efficient manner. For example, as more and more PBCs are created by software vendors, it will become increasingly challenging to keep track of all available PBCs and their respective characteristics. For some common business domains such as finance and marketing/sales, there could conceivably be hundreds of PBCs with overlapping or disparate feature sets, varying cost structures, different service level agreements (SLAs), different availability zones, and so on. In addition, ongoing changes to regulatory requirements, shifting technology trends, and the evolution of cyberattacks and malware add further layers of complexity to the solution architecture design process that must be constantly monitored and accounted for.

To address the foregoing and other related issues, the VSA of the present disclosure is a computer-implemented agent that receives natural language queries from users pertaining to the design/creation of a solution architecture and automatically generates natural language answers that are responsive to those queries. For example, a user may submit the following query: “My restaurant retail business has been experiencing poor sales lately. How can I implement online ordering to increase my customer reach and improve my revenue?” In response, the VSA can provide a natural language description of a proposed solution architecture that includes various PBCs usable for implementing this functionality (e.g., a product listing service with support for food items, a shopping cart tool, an order fulfillment service with support for in-person pickup or delivery, etc.) and a technical plan indicating how these PBCs should be integrated from beginning to end in order to meet the user's stated objectives.

As described in further detail below, the VSA executes two types of workflows that may run sequentially or concurrently with each other: knowledge collection and query processing. Knowledge collection generally comprises collecting, from various knowledge sources, information relevant to the solution architecture design process (referred to as solution design knowledge), such as information regarding common business processes and their relationships to other entities (e.g., PBCs, business domains, industries, etc.), solution architecture design best practices, PBC application programming interface (API) information, help information presented on the websites of various PBC vendors, so on. The collected solution design knowledge is populated in a knowledge graph database (in the case of business process relationship information) or in a vector database (in the case of other types of information).

Query processing generally comprises receiving, from a user, a natural language query directed to the creation/design of a solution architecture; determining the types of collected solution design knowledge needed to answer the query; retrieving the required knowledge from the knowledge graph database and/or the vector database; building an LLM prompt that includes both the query text and context information (referred to as a context set) that includes the retrieved knowledge; and submitting the prompt as input to an LLM, thereby causing the LLM to output a natural language answer that is responsive to the query. For example, the answer may include a natural language description of a proposed solution architecture that meets business objectives stated in the query, as well as natural language explanations of the solution architecture's various features and components.

By leveraging LLMs in this manner and by contextualizing the query provided as input to the LLM with relevant solution design knowledge, the VSA of the present disclosure can produce natural language answers that are coherent, detailed, and similar in usefulness to the answers that would be provided by a human solution architect. Accordingly, the VSA can advantageously accelerate, and in some cases completely automate, the solution architecture design process.

### 1. VSA Architecture

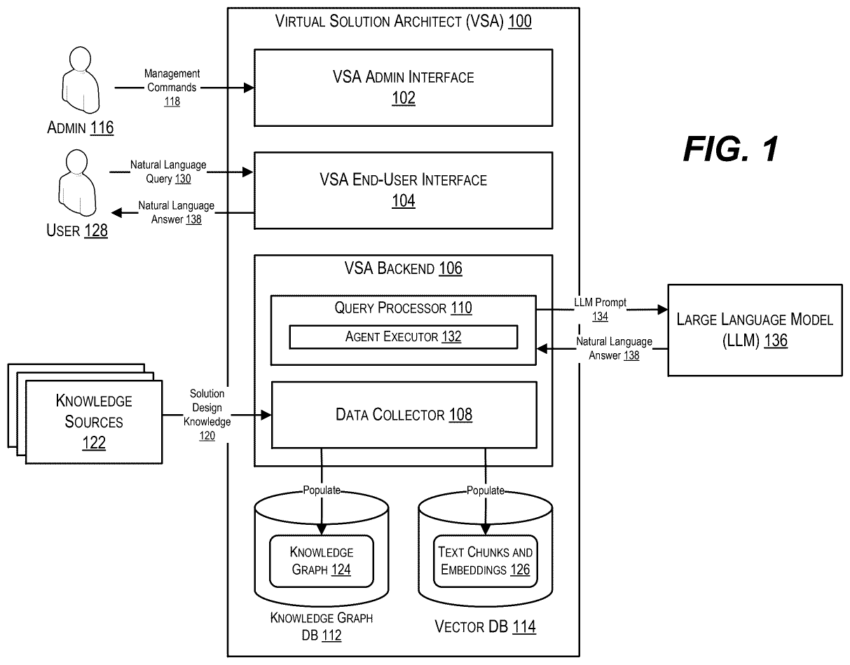

FIG. 1 is a simplified block diagram illustrating the high-level architecture of a VSA 100 according to certain embodiments of the present disclosure. As shown, VSA 100 includes a VSA administrator (admin) interface 102, a VSA end-user interface 104, a VSA backend 106 comprising a data collector 108 and a query processor 110, a knowledge graph database 112, and a vector database 114. Each of these components may be implemented in software, in hardware, or a combination thereof.

VSA admin interface 102 provides a mechanism through which an administrator 116 can submit management commands 118 for managing the configuration and operation of VSA 100. VSA admin interface 102 may implemented as a graphical user interface (UI), a text-based UI, and/or a programmatic interface (e.g., an application programming interface (API)). Upon receiving management commands 118, VSA admin interface 102 can forward the commands to VSA backend 106 and the backend can execute the commands accordingly.

In one set of embodiments, VSA admin interface 102 can specifically enable administrator 116 to control data collector 108 of VSA backend 106 to collect (either on a periodic basis or on-demand) solution design knowledge 120 from various knowledge sources 122 and populate the collected knowledge in knowledge graph database 112 or vector database 114. Solution design knowledge 120 can include, e.g., business process relationship information collected from a PBC marketplace or repository, PBC help information collected from the help websites of PBC vendors, PBC API information collected from PBC API documentation, solution design best practices collected from electronic (e.g., portable document format (PDF) or text) documents, and so on.

In the case of business process relationship information (e.g., information identifying common business processes and relationships between those processes and other entities such as PBCs, business domains, industries, business activities, etc.), data collector 108 can store the collected knowledge in the form of a knowledge graph 124 maintained in knowledge graph database 112. In the case of other types of information (e.g., PBC API or help information, etc.), data collector 108 can convert and/or split the collected knowledge into text chunks, create a dense vector (known as an embedding) of each text chunk that encodes its meaning, and store the text chunks and their corresponding embeddings (shown via reference numeral 126) in vector database 114. Sections (2) and (3) below describe example knowledge collection workflows that may be executed by data collector 108 for populating knowledge graph database 112 and vector database 114 respectively.

VSA end-user interface 104 provides a mechanism through which a user 128 of VSA 100 can submit a natural language query 130 pertaining to a solution architecture that the user is interested in creating/designing. For example, user 128 may submit a query asking VSA 100 to provide a proposed design for a solution architecture that addresses one or more business needs or objectives of the user. Like VSA admin interface 102, VSA end-user interface 104 can be implemented as a graphical UI, a text-based UI, and/or a programmatic interface. In the case of a graphical UI or a text-based UI, VSA end-user interface 104 may be presented to user 128 in various ways, such as on a website, within the UI of a software application (e.g., a mobile app), etc.

Upon receiving natural language query 130, VSA end-user interface 104 can forward it to query processor 110 of VSA backend 106. In response, query processor 110 determine, using an agent executor 132, a plan for responding to the query; identify, based on the determined plan, the types of collected solution design knowledge that are needed for responding to the query; retrieve the identified solution design knowledge stored in databases 112 and 114; build an LLM prompt 134 that includes natural language query 130 and contextual information corresponding to the retrieved solution design knowledge; and provide prompt 134 as input to an LLM 136, thereby causing the LLM to output a natural language answer 138 that is responsive to the query. As known in the art, an LLM is a type of generative AI model that is trained on large textual datasets and can interpret and generate natural language text. In one set of embodiments, LLM 136 may be a generic/foundational LLM that is solely trained on publicly available data, such as data available on the Internet. In another set of embodiments (described in section (5) below), LLM 136 may be a fine-tuned version of a generic/foundational LLM that is further trained on a proprietary training data set comprising the types of solution design knowledge collected in knowledge graph database 112 and/or vector database 114.

Finally, query processor 110 can receive natural language answer 138 and forward it to VSA end-user interface 104, which can in turn provide/present the answer to user 128. Section (4) below describes an example workflow that provides additional details regarding the processing that may be performed by query processor 110 for handling natural language query 130.

It should be appreciated that FIG. 1 and the foregoing high-level architecture description are illustrative and not intended to limit embodiments of the present disclosure. For instance, while FIG. 1 depicts a particular arrangement of components in VSA 100, other arrangements are possible (e.g., the functionality attributed to a particular component may be split into multiple components, components may be combined or integrated into other components, etc.). As one example, in some embodiments vector database 114 may be split into multiple vector databases, where each individual vector database stores text chunks and embeddings for a particular knowledge source or for a particular type of solution design knowledge. One of ordinary skill in the art will recognize other similar variations, modifications, and alternatives.

### 2. Collection of Business Process Relationship Information

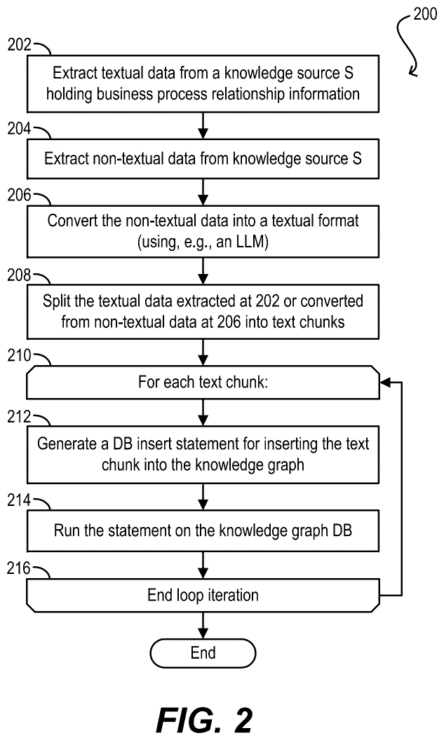

FIG. 2 depicts a workflow 200 that may be executed by data collector 108 of VSA backend 106 for collecting business process relationship information from a knowledge source S that holds such information (e.g., a PBC marketplace/repository) and populating this business process relationship information in knowledge graph 124 of knowledge graph database 112 according to certain embodiments. An example of business process relationship information is information that identifies a business process P, the PBCs available for implementing P, the business domains to which P belongs, the industries for which P is relevant, the business activities for which P is used, and so on.

Starting with step 202, data collector 108 can extract textual data from knowledge source S (i.e., the source holding business process relationship information). For example, if knowledge source S is a website, data collector 108 can crawl the webpages of the website and extract the text from each webpage. If the knowledge source is a set of documents, VSA backend 106 can extract the text from each document.

At step 204, data collector 108 can extract non-textual data from knowledge source S. Examples of non-textual data include drawings, diagrams, and tables. Data collector 108 can then convert the non-textual data into a textual format (step 206). In one set of embodiments, data collector 108 can perform this conversion by providing the non-textual data as input to LLM 136 of FIG. 1 and asking the LLM to explain the content of the non-textual data using natural language. Alternatively, data collector 108 can provide the non-textual data as input to a different LLM that is specifically trained in performing such a task.

Upon obtaining the textual data extracted at step 202 or converted from non-textual data at step 206, data collector 108 can split the extracted textual data into a plurality of text chunks (step 208). Data collector 108 can use any known text chunking algorithm for this purpose.

Data collector 108 can thereafter enter a loop for each text chunk created at step 208 (step 210). Within this loop, data collector 108 can generate a database insert statement, such as a Cypher CREATE statement, for inserting the content of the text chunk (i.e., the business process relationship information contained therein) into knowledge graph 124 of knowledge graph database 112 (step 212). In one set of embodiments, data collector 108 can perform step 212 by providing the text chunk and a schema of knowledge graph database 112 to LLM 136 and asking the LLM to generate the database insert statement based on these inputs. Alternatively, data collector 108 can perform step 212 using other methods.

Data collector 108 can subsequently run the database insert statement on knowledge graph database 112, thereby inserting the business process relationship information contained in the text chunk into knowledge graph 124 (step 214), reach the end of the current loop iteration (step 216), and return to the top of the loop in order to process the next text chunk. Once all text chunks are processed, workflow 200 can end.

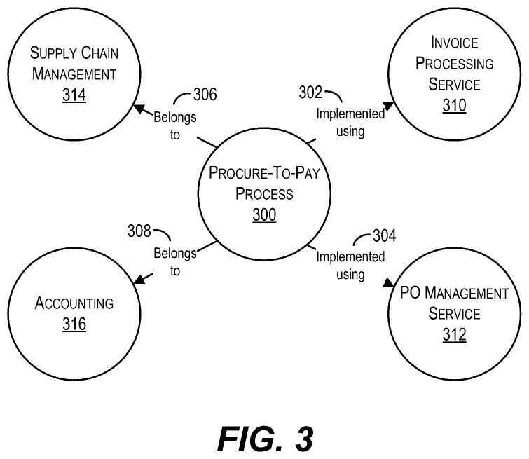

By way of example, FIG. 3 depicts a set of knowledge graph nodes 300-316 that may be created in knowledge graph 124 via steps 210 and 212 of workflow 200. As shown, these knowledge graph nodes include a business process node 300 corresponding to the business process “Procure-to-Pay.” Business process node 300 is connected via a number of relationship links 302-308 to other nodes 310-316, thereby identifying relationships between the procure-to-pay business process and the entities corresponding to nodes 310-316. For example, relationship links 302 and 304 indicate that the procure-to-pay business process can be implemented using the PBCs “Invoice Processing Service” (node 310) and “Purchase Order (PO) Management Service” (node 312). In addition, relationship links 306 and 308 indicate that the procure-to-pay business process belongs to the enterprise domains “Supply Chain Management” (node 314) and “Accounting” (node 316).

### 3. Collection of Other Information

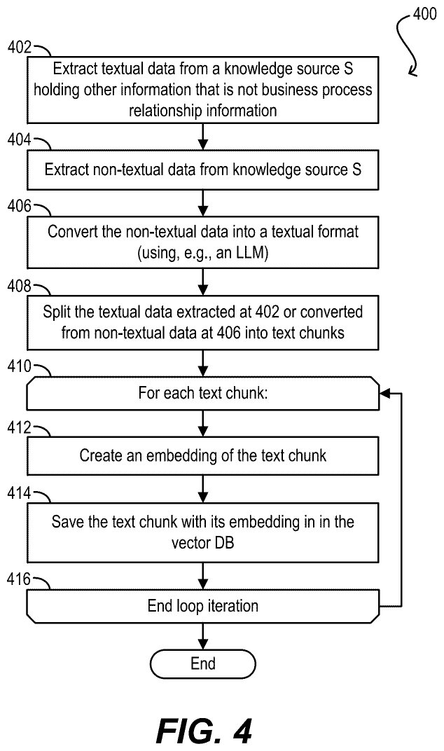

FIG. 4 depicts a workflow 400 that may be executed by data collector 108 of VSA backend 106 for collecting information that is not business process relationship information (referred to as “other information”) from a knowledge source S and populating this information in vector database 114 according to certain embodiments. Examples of other information that data collector 108 may collect via workflow 400 include help information presented on a help website of a software vendor that develops and sells one or more PBCs, PBC API documentation, and solution design-related information (e.g., solution design best practices, etc.) contained in one or more electronic (e.g., PDF or text) documents.

Starting with step 402, data collector 108 can extract textual data from knowledge source S (i.e., the source holding the other information). For example, if knowledge source S is a website, data collector 108 can crawl the webpages of the website and extract the text from each webpage. If the knowledge source is a set of documents, VSA backend 106 can extract the text from each document.

At step 404, data collector 108 can extract non-textual data from knowledge source S. Examples of non-textual data include drawings, diagrams, and tables. Data collector 108 can then convert the non-textual data into a textual format (step 406). In one set of embodiments, data collector 108 can perform this conversion by providing the non-textual data as input to LLM 136 of FIG. 1 and asking the LLM to explain the content of the non-textual data using natural language. Alternatively, data collector 108 can provide the non-textual data as input to a different LLM that is specifically trained in performing such a task.

Upon obtaining the textual data extracted at step 402 or converted from non-textual data at step 406, data collector 108 can split the extracted textual data into a plurality of text chunks (step 408). Data collector 108 can use any known text chunking algorithm for this purpose.

Data collector 108 can thereafter enter a loop for each text chunk created at step 408 (step 410). Within this loop, data collector 108 can create an embedding of the text chunk, where the embedding is a dense vector that represents the semantic content of the text chunk in a mathematical format (step 412). In one set of embodiments, data collector 108 can perform step 412 by providing the text chunk to an AI model that is specifically designed for this task, known as an embedding model, and asking the embedding model to create the embedding. Alternatively, data collector 108 can perform step 412 using other methods.

Data collector 108 can subsequently save the text chunk along with its embedding in vector database 114 (step 414), reach the end of the current loop iteration (step 416), and return to the top of the loop in order to process the next text chunk. Once all text chunks are processed, workflow 400 can end.

### 4. Query Processing

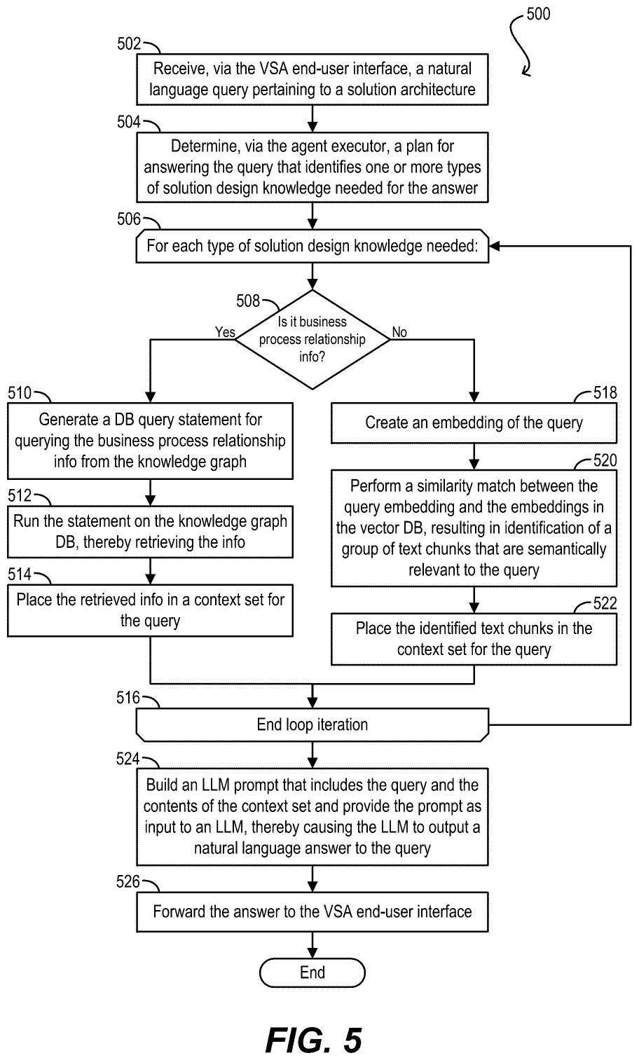

FIG. 5 depicts a workflow 500 that may be executed by query processor 110 of VSA backend 106 for processing a natural language query according to certain embodiments. Workflow 500 assumes that knowledge graph database 112 and vector database 114 have been populated with solution design knowledge in the form of knowledge graph 124 and text chunks/embeddings 126 via knowledge collection workflows 200 and 400 respectively.

Starting with step 502, query processor 110 can receive, via VSA end-user interface 104, a natural language query from, e.g., user 128 pertaining to the design/creation of a solution architecture. For example, the natural language query may specify one or more business needs or objectives and may ask the VSA to propose a solution architecture for addressing those needs/objectives. Alternatively, the natural language query may ask a question relating to an existing solution architecture, such as how the existing solution architecture can be improved.

At step 504, query processor 110 can determine, using its agent executor 132, a logical plan for answering the natural language query, where the plan identifies one or more types of solution design knowledge that are needed for the answer. Agent executor 132 (which can be a singular executor entity or consist of multiple executors) can employ a known AI technique such as Chain of Thought or ReAct in order to determine this plan. Query processor 110 can then enter a loop for teach type of solution design knowledge needed (step 506).

Within the loop, query processor 110 can check whether the type of solution design knowledge needed is business process relationship information contained in knowledge graph 124 or other information contained in text chunks/embeddings 126 (step 508). If the required knowledge is business process relationship information, query processor 110 can generate a database query statement, such as a Cypher MATCH statement, for retrieving that information from knowledge graph 124 (step 510) and can run the database query statement on knowledge graph database 112, thereby retrieving that information (step 512). Like the database insert statement generated at step 212 of workflow 200, query processor 110 can generate this database query statement by providing the natural language query and the schema of knowledge graph database 112 to LLM 136 (or another LLM) and asking the LLM to generate the statement based on these inputs. Query processor 110 can then place the retrieved business process relationship information in a context set for the natural language query (step 514), reach the end of the current loop iteration (step 516), and return to the top of the loop in order to process the next type of required solution design knowledge.

On the other hand, if query processor 110 determines at step 508 that the required knowledge is other information contained in text chunks/embeddings 126, query processor 110 can create an embedding of the query (i.e., query embedding) (step 518). Like the text chunk embedding created at step 412 of workflow 400, query processor 110 can create this query embedding by providing the natural language query to an embedding model and asking the embedding model to create the embedding.

At step 520, query processor 110 can perform a similarity match between the query embedding and the embeddings held in vector database 114. This similarity match identifies a group of embeddings in vector database 114 that are most similar to the query embedding, and thus a group of text chunks in vector database 114 (corresponding to the matched group of embeddings) that are most semantically relevant to the natural language query. Query processor 110 can then place the identified group of text chunks in the context set for the natural language query (step 522), reach the end of the current loop iteration (step 516), and return to the top of the loop in order to process the next type of required solution design knowledge.

Upon processing all knowledge types, query processor 110 can build an LLM prompt that includes the natural language query and the contents of the context set populated at steps 514 and 522 and can provide the prompt to LLM 136, thereby causing the LLM to output a natural language answer that is responsive to the query (step 524). Finally, at step 526, VSA backend 106 can forward the natural language answer to VSA end-user interface 104 (which can present/provide the answer to the query originator) and workflow 500 can end.

It should be appreciated that various modifications and enhancements to workflow 500 are possible. For example, in some embodiments query processor 110 may make use of a conversation memory database that is configured to store the natural language answer output by LLM 136 at step 526. In these embodiments, when the same user submits a subsequent natural language query to VSA 100, query processor 110 can retrieve the previous answer from the conversation memory database and add this answer to the context set for the subsequent query. This approach allows LLM 136 to understand the subsequent query as being part of an ongoing conversation with the user and thus generate a more appropriate answer to that query.

Further, in some embodiments query processor 110 may employ a semantic caching component that caches all user-submitted queries and their corresponding answers as vectors in, e.g., a memory of VSA 100. If any user asks a query that is semantically similar to one of the cached queries, query processor 110 can immediately return the answer stored in the semantic caching component, thereby avoiding the need to carry out the entirety of query processing workflow 500 on that query.

Yet further, in addition to contextualizing the natural language query with information retrieved from knowledge graph database 112 and/or vector database 114, in some embodiments query processor 110 may also contextualize the query with other types of information. For example, consider a scenario in which the natural language query includes both a request to provide a proposed solution architecture for a particular business use case and a request to provide a diagram of that solution architecture. In this scenario, query processor 110 can ask LLM 136 to create the diagram and then add the diagram to the context set for the query, thereby enabling LLM 136 to output a final answer/response that incorporates the diagram (along with a textual description of the solution architecture).

### 5. Employing an LLM Trained on Solution Design Knowledge

As mentioned previously, in certain embodiments LLM 136 shown in FIG. 1 can be an LLM that is trained (or more precisely, fine-tuned) on a proprietary (i.e., non-public) training data set that includes some or all of the types of solution design knowledge maintained in knowledge graph database 112 and/or vector database 114. This allows LLM 136 to have a fundamental understanding of business process relationships, PBCs, and solution design principles and best practices that may not be found in generic/foundational LLMs, and thus enables the LLM to produce better answers to user-submitted queries.

In these embodiments, at the time of processing a query, query processor 110 of VSA backend 106 can still retrieve solution design knowledge from databases 112 and 114 and augment/contextualize the prompt provided as input to the fine-tuned LLM with this retrieved information in accordance with workflow 500 of FIG. 5, because databases 112 and 114 may contain more up-to-date solution design knowledge than the fine-tuned LLM. In scenarios where query processor 110 specifically knows that there is no difference in the knowledge contained in databases 112 and 114 and the knowledge used to train the fine-tuned LLM, query processor 110 can omit the knowledge retrieval steps of workflow 500 and simply forward the user query to the LLM for handling.

### 6. Example Computer System

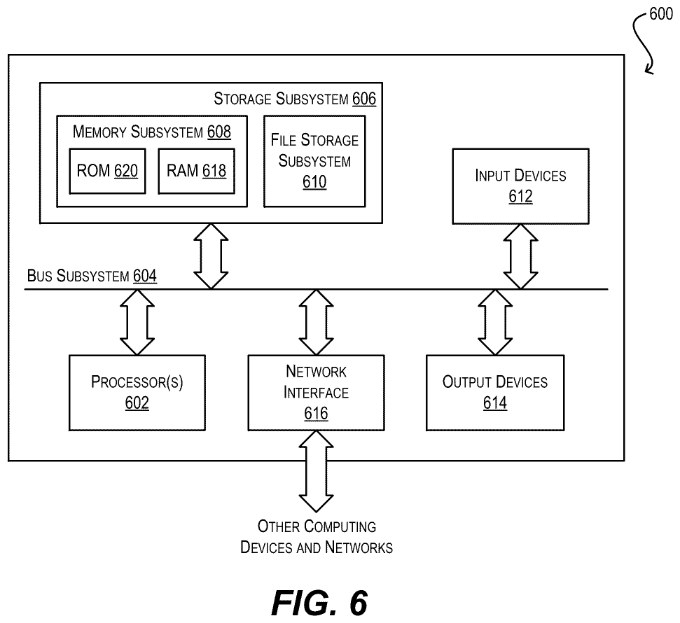

FIG. 6 is a simplified block diagram of an example computer system 600 according to certain embodiments. Computer system 600 (and/or equivalent systems/devices) may be used to run any of the software described in the foregoing disclosure, including VSA 100 of FIG. 1 and its constituent components. As shown in FIG. 6, computer system 600 includes one or more processors 602 that communicate with a number of peripheral devices via a bus subsystem 604. These peripheral devices include a storage subsystem 606 (comprising a memory subsystem 608 and a file storage subsystem 610), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple buses.

Network interface subsystem 616 can serve as an interface for communicating data between computer system 600 and other computer systems or networks. Embodiments of network interface subsystem 616 can include, e.g., an Ethernet module, a Wi-Fi and/or cellular connectivity module, and/or the like.

User interface input devices 612 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 600.

User interface output devices 614 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 600.

Storage subsystem 606 includes a memory subsystem 608 and a file/disk storage subsystem 610. Subsystems 608 and 610 represent non-transitory computer-readable storage media that can store program code and/or data which provide the functionality of embodiments of the present disclosure in a non-transitory state.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of non-volatile storage media known in the art.

It should be appreciated that computer system 600 is illustrative and other configurations having more or fewer components than computer system 600 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

What is claimed is:

1. A method performed by one or more computer systems for implementing a virtual solution architect (VSA), the method comprising:
collecting knowledge relevant to technology solution architecture design, the collected knowledge including:
a knowledge graph comprising business processes and relationships between each business process and other entities;
a first set of text chunks and associated embeddings, the first set of text chunks originating from application programming interface (API) documentation for a plurality of packaged business capabilities (PBCs); and
a second set of text chunks and associated embeddings, the second set of text chunks originating from one or more help websites of one or more vendors of the PBCs;
receiving a natural language query pertaining to a technology solution architecture;
retrieving at least a portion of the collected knowledge based on the natural language query;
building a prompt for a large language model (LLM) using the natural language query and the retrieved portion of the collected knowledge;
providing the prompt as input to the LLM, thereby causing the LLM to output a natural language answer to the natural language query; and
providing the natural language answer to an originator of the natural language query.

2. The method of claim 1 wherein the natural language answer comprises a proposed design for the technology solution architecture.

3. The method of claim 2 wherein the natural language query includes one or more business objectives that should be achieved by the technology solution architecture, and wherein the proposed design includes a subset of the plurality of PBCs and a plan for integrating the subset in order to meet the one or more business objectives.

4. The method of claim 1 wherein the other entities include one or more PBCs associated with the business process, one or more business domains to which the business process belongs, and one or more industries that the business process is relevant for.

5. The method of claim 1 wherein the collected knowledge further includes a third set of text chunks and associated embeddings, the third set of text chunks originating from one or more electronic documents.

6. The method of claim 1 wherein collecting the knowledge comprises:
extracting textual data from a knowledge source that holds business process relationship information;
extracting non-textual data from the knowledge source;
converting the non-textual data into further textual data;
splitting the textual data and the further textual data into a plurality of text chunks; and
for each text chunk:
generating a database insert statement for inserting content of the text chunk into a knowledge graph database storing the knowledge graph; and
running the database insert statement on the knowledge graph database.

7. The method of claim 6 wherein the database insert statement is generated by providing the content of the text chunk and a schema of the knowledge graph database to the LLM.

8. The method of claim 1 wherein collecting the knowledge comprises:
extracting textual data from the API documentation and the one or more help websites;
extracting non-textual data from the API documentation and the one or more help websites;
converting the non-textual data into further textual data;
splitting the textual data and the further textual data into a plurality of text chunks; and
for each text chunk:
creating an embedding of the text chunk; and
storing the text chunk and the embedding in a vector database of the VSA.

9. The method of claim 8 wherein the embedding is created by providing the text chunk as input to an embedding model.

10. The method of claim 1 wherein the retrieving comprises:
determining a plan for answering the natural language query; and
identifying, from the plan, one or more types of solution design knowledge needed to answer the answer the natural language query.

11. The method of claim 10 wherein the retrieving further comprises, upon determining that the one or more types of solution design knowledge include business process relationship information:
determining, based on the natural language query, a database query statement for querying the business process relationship information in the knowledge graph;
running the database query statement on a knowledge graph database storing the knowledge graph, thereby causing the knowledge graph database to output the business process relationship information; and
placing the business process relationship information in a context set for the natural language query.

12. The method of claim 11 wherein the database query statement is generated by providing the natural language query and a schema of the knowledge graph database to the LLM.

13. The method of claim 11 wherein the retrieving further comprises, upon determining that the one or more types of solution design knowledge include other information that is not business process relationship information:
creating an embedding of the natural language query;
performing a first similarity match between the embedding of the natural language query and the associated embeddings of the first set of text chunks, the performing of the first similarity match resulting in identification of one or more first text chunks in the first set that are relevant to the natural language query; and
placing the one or more first text chunks in the context set.

14. The method of claim 13 wherein the embedding is created by providing the natural language query as input to an embedding model.

15. The method of claim 13 wherein the retrieving further comprises:
performing a second similarity match between the embedding of the natural language query and the associated embeddings of the second set of text chunks, the performing of the second similarity match resulting in identification of one or more second text chunks in the second set that are relevant to the natural language query; and
placing the one or more second text chunks in the context set.

16. The method of claim 15 wherein building the prompt comprises including the natural language query and the context set in the prompt.

17. The method of claim 1 further comprising:
storing the natural language answer in a conversational memory database of VSA; and
upon receiving a second natural language query from the originator of the natural language query:
retrieving the natural language answer from the memory database; and
adding the retrieved natural language answer to an LLM prompt that is built for the second natural language query.

18. A non-transitory computer readable storage medium having stored thereon instructions executable by one or more computer systems implementing a virtual solution architect (VSA), the instructions causing the one or more computer systems to:
collect knowledge relevant to technology solution architecture design, the collected knowledge including:
a knowledge graph comprising business processes and relationships between each business process and other entities;
a first set of text chunks and associated embeddings, the first set of text chunks originating from application programming interface (API) documentation for a plurality of packaged business capabilities (PBCs); and
a second set of text chunks and associated embeddings, the second set of text chunks originating from one or more help websites of one or more vendors of the PBCs;
receive a natural language query pertaining to a technology solution architecture;
retrieve at least a portion of the collected knowledge based on the natural language query;
build a prompt for a large language model (LLM) using the natural language query and the retrieved portion of the collected knowledge;
provide the prompt as input to the LLM, thereby causing the LLM to output a natural language answer to the natural language query; and
provide the natural language answer to an originator of the natural language query.

19. A computer system comprising:
one or more processors; and
a computer readable storage medium having stored thereon program code that, when executed by the one or more processors, cause the one or more processors to:
collect knowledge relevant to technology solution architecture design;
receive a natural language query requesting a proposed design for a technology solution architecture and identifying one or more business objectives that should be achieved by the technology solution architecture;
retrieve at least a portion of the collected knowledge based on the natural language query;
build a prompt for a large language model (LLM) using the natural language query and the retrieved portion of the collected knowledge;
provide the prompt as input to the LLM, thereby causing the LLM to output a natural language answer to the natural language query, the natural language answer including the proposed design for the technology solution architecture; and
provide the natural language answer to an originator of the natural language query.

20. The computer system of claim 19 wherein the collected knowledge includes:
a knowledge graph comprising business processes and relationships between each business process and other entities;
a first set of text chunks and associated embeddings, the first set of text chunks originating from application programming interface (API) documentation for a plurality of packaged business capabilities (PBCs); and
a second set of text chunks and associated embeddings, the second set of text chunks originating from one or more help websites of one or more vendors of the PBCs.
